(19) United States
(12) Patent Application Publication
(10) Pub. No.: US 2005/0128570 A1
(43) Pub. Date: Jun. 16, 2005

(54) Top-pumped optical device

(76) Inventors: Jung-Hoon Shin, Daejon (KR); Nam-Kyoo Park, Seoul (KR)

Correspondence Address: MARGER JOHNSON & MCCOLLOM, P.C., 1030 SW MORRISON STREET, PORTLAND, OR, 97205, US

(21) Appl. No.: 10/507,270

(22) PCT Filed: Mar. 11, 2003
(86) PCT No.: PCT/KR03/00467

(30) Foreign Application Priority Data
Mar. 11, 2002 (KR) 10-2002-0012911

(51) Int. Cl. H01S 3/00

(52) U.S. Cl. 359/341.3

(57) ABSTRACT

Disclosed is an optical device with enhanced pumping efficiency where light from a pumping light source is efficiently absorbed in a gain medium structure placed under the pumping light. The major characteristic of the optical device of the present invention is that it is top-pumped and a portion in the gain medium structure, which is included in a beam spot of the light source, has a larger area than other portions in the gain medium structure. According to the present invention, a top-pumped optical device with higher pumping efficiency can be provided.

### TECHNICAL FIELD

The present invention relates to a top-pumped optical device, and more particularly to an optical device with an enhanced pumping efficiency where light from a pumping light source is efficiently absorbed in a gain medium structure placed under the pumping light source.

### BACKGROUND ART

Generally, lasers have been used in the pumping of optical devices such as optical wave guide amplifiers. A laser light source has a high efficiency. Further, since the laser does not spread due to its high coherence, the laser light source can pump the devices at a high strength. However, the laser light source emits light in a limited wavelength band. Therefore, in order to solve this problem, a high power flash lamp is used as a pumping light source to output light in a broad wavelength band. However, such a flash lamp has disadvantages in that it has a large size and low efficiency, and requires high voltage or current during the operation.

Accordingly, since a LED (Light Emitting Diode) has been recently developed to output light in a broadened wavelength band and enhanced efficiency, the use of the LED as a replacement for the conventional pumping light source has been proposed. However, in case that the LED is used as a pumping light source, since the light is dispersed from a very small area of the LED in all directions, the effective pumping efficiency of the LED light source may be smaller than the theoretical pumping efficiency of the LED light source. Therefore, the LED light source may not be employed in a top-pumping arrangement of the optical device.

U.S. Pat. No. 6,043,929 issued to Delavaux et al. on Mar. 28, 2000 discloses an adiabatic waveguide amplifier. In this patent, an optical waveguide structure comprises three separate regions with different widths, i.e., a single mode region, an adiabatic region, and a multimode region, so as to improve the amplification efficiency of the amplifier. However, the technique disclosed by the above patent employs a side-pumping arrangement in which pumping light from a pumping light source is inputted into the waveguide via an input terminal, thus yielding several disadvantages, as follows.

First, in the case that the pumping light inputted into the multimode region of the waveguide, the signal light cannot be uniformly amplified since the pumping light is not uniformly dispersed throughout the multimode region.

Second, since the pumping light is inputted into the multimode region, in which most of the amplification occurs, after passing through the single mode region and the adiabatic region, the a do not contribute to amplification, the actual strength of amplification may be weak.

### DISCLOSURE OF THE INVENTION

Therefore, the present invention has been made in view of the above problems, and it is an object of the present invention to provide an optical device with enhanced pumping efficiency where light from a pumping light source is efficiently absorbed in a gain medium structure placed under the pumping light source.

It is another object of the present invention to provide an optical device with a structure in which light from the pumping light source can be incident on a gain medium region in which most of the amplification occurs without reducing the strength of the light.

In accordance with the present invention, the above and other objects can be accomplished by the provision of a top-pumped optical device comprising: a substrate; a lower cladding layer formed on the substrate; a gain medium structure formed on the lower cladding layer and excited by absorbing pumping light; and a light source disposed above the gain medium structure for pumping the gain medium structure by means of light directed downward therefrom, wherein a portion of the gain medium structure, which is included in a beam spot of the light source, has a larger area than other portions of the gain medium structure.

Preferably, the top-pumped optical device may further comprise an upper cladding layer formed on the gain medium structure, and the upper cladding layer may be made of a material which transmits the light irradiated from the pumping light source.

Further, preferably, the gain medium structure shall not exhibit a great absorption property in the signal wavelength band of the optical device, but exhibit a great absorption property in other wavelength bands, and the gain medium may be made of one selected from the group consisting of a macromolecular substance doped with excited elements, a silica-based substance doped with excited elements, a chalcogenide glass substance doped with excited elements, and a GaN or GaN-based substance doped with excited elements. More preferably, the gain medium may be doped with nano-crystals as well as the excited elements, and most preferably, the excited elements may be rare-earth elements.

Moreover, preferably, the pumping light source may be a LED.

Besides, preferably, the gain medium structure may include adiabatic portions between the portion with the larger area and other portions.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the operation of a conventional top-pumped optical device, e.g., an optical waveguide amplifier;

FIG. 2 is a schematic view of an optical waveguide amplifier in accordance with an embodiment of the present invention; and

FIG. 3 is a schematic view illustrating an adiabatic variation in the width of an optical waveguide used in the optical waveguide amplifier of FIG. 2.

### BEST MODE FOR CARRYING OUT THE INVENTION

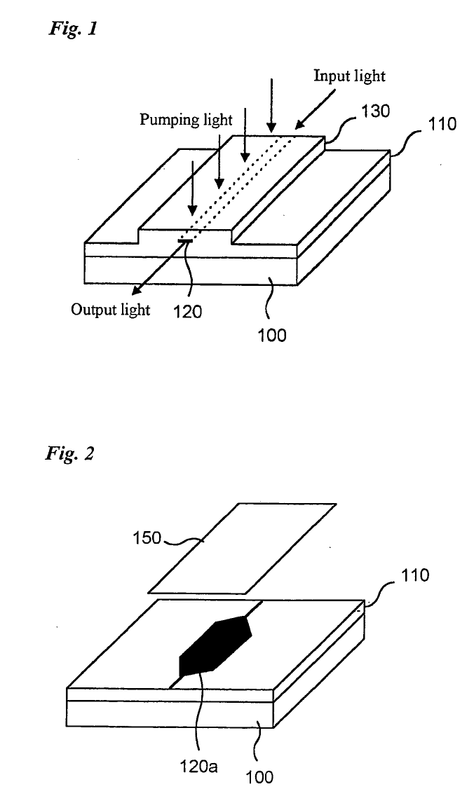

Now, before a preferred embodiment of the present invention is described, the operation of a conventional top-pumped optical device, e.g., an optical waveguide amplifier is described with reference to FIG. 1.

With reference to FIG. 1, a lower cladding layer 110 made of silica is formed on a substrate 100, and a core layer made of silica-based substance doped with nano-crystals and rare-earth elements is formed on the lower cladding layer 110. Here, the core layer serves as a waveguide 120. An upper cladding layer 130 made of silica is formed on the waveguide 120. A broad-band light source (not shown) is installed above the waveguide 120 so that pumping light is irradiated from the light source onto the top surface of the waveguide 120. The light inputted into the waveguide 120 creates electrons and holes in the nanocrystals that recombine, thus allowing the rare-earth elements to be excited. The input light receives energy from the excited rare-earth elements, is amplified by passing through the waveguide 120, and then outputted from the waveguide 120.

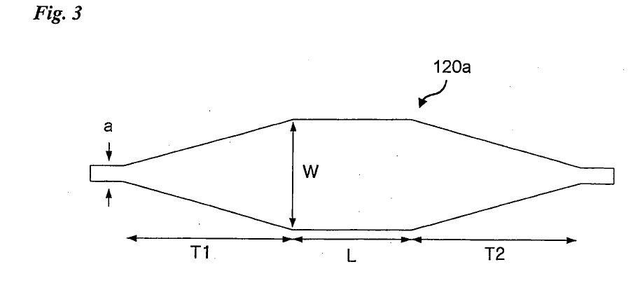

Hereinafter, with reference to FIGS. 2 and 3, an optical waveguide amplifier in accordance with the embodiment of the present invention is described in detail.

FIG. 2 shows the optical waveguide amplifier in accordance with the embodiment of the present invention. Here, an upper cladding layer is removed for clarity of description.

With reference to FIG. 2, the lower cladding layer 110 made of silica is formed on the substrate 100, and a core layer made of silica-based substance doped with nano-crystals and rare-earth elements is formed as a waveguide 120a on the lower cladding layer 110. Differently from the linear structure of the above-described conventional waveguide 120, the waveguide 120a of the present invention has a structure with a portion included in a beam spot of a LED light source 150, which has a larger area than other portions. The omitted upper cladding layer has a thickness of approximately several tens of μm, and is made of a material which transmits pumping light irradiated from the LED light source 150 so that the pumping light reaches the waveguide 120a. The LED light source 150 serving as a pumping light source is installed above the omitted upper cladding layer. The LED light source 150 may be spaced from the omitted upper cladding layer by a designated distance, or contact the omitted upper cladding layer. The waveguide 120a with the above-described structure absorbs a large quantity of the pumping light irradiated from the LED light source 150, and increases amplification efficiency of the optical waveguide amplifier. The LED light source 150 for generating the pumping light to be inputted into the waveguide 120a does not employ the conventional side-pumping arrangement in which the LED light source is connected to an input terminal of the waveguide 120a, but employs a top-pumping arrangement in which the LED light source 150 is located above the waveguide 120a, thus allowing the pumping light from the LED light source 150 to be uniformly irradiated onto the increased area of the waveguide 120a. Accordingly, it is possible to uniformly amplify a signal wave. Further, since the pumping light is immediately incident on the increased area of the waveguide 120a after the pumping light passes through only the upper cladding layer with the thickness of approximately several tens of μm, it is possible to prevent any reduction of the strength of the pumping light.

FIG. 3 illustrates an adiabatic variation in the width of the optical waveguide 120a used in the optical waveguide amplifier of FIG. 2. Here, the adiabatic variation in the width of the optical waveguide 120a has been well known in the field of the optical waveguide. The width of the optical waveguide is not suddenly varied but is gradually varied in order to prevent the sudden change of the mode characteristics of a signal wave passing through the optical waveguide. With reference to FIG. 3, the optical waveguide is divided into a narrow portion with a small width (a) and a wide portion with a large width (W). The variation in the width of the waveguide 120a between the narrow portion and the wide portion is configured so that the width of the waveguide 120a is tapered at adiabatic portions T1 and T2. The waveguide 120a used in the embodiment of the present invention is patterned such that the narrow portion has the small width (a) of 10 μm, the wide portion has the large width (W) of 100 μm and the length (L) of 100 μm, and the adiabatic portions T1 and T2 have the lengths of 1 cm. The waveguide 120a is not limited to the set of the above parameters, but may have other various sets of parameters if the change of mode characteristics of the signal wave passing through the waveguide 120a can be prevented by the structure of the waveguide 120a. The set of parameters may be determined by the signal wave passing through the waveguide 120a after the waveguide 120a is produced. However, generally, the set of parameters are predicted and determined based on the results of a simulation, and subsequently the waveguide 120a is produced based on the determined set of parameters.

Instead of the adiabatic variation in the area of the waveguide, other methods may be used in order to prevent the change of mode characteristics of the signal wave passing through the waveguide. For example, a method for adjusting the refractivity of the cladding layer has been frequently used in the field of the waveguide.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

That is, the optical device achieved by the present invention is not used only in a waveguide amplifier, but also may be used in a passive PIC (Photonic Integrated Circuit) such as an optical splitter, an optical demultiplexer, or an optical multiplexer.

### Industrial Applicability

As apparent from the above description, the present invention provides a top-pumped optical device with enhanced plumping efficiency where light from a pumping light source is efficiently absorbed in a gain medium structure placed under the pumping light.

1. A top-pumped optical device comprising:
a substrate;
a lower cladding layer formed on the substrate;
a gain medium structure formed on the lower cladding layer and excited by absorbing pumping light; and
a light source disposed above the gain medium structure for pumping the gain medium structure by means of light directed downward therefrom,
wherein a portion of the gain medium structure, which is included in a beam spot of the light source, has a larger area than other portions of the gain medium structure.

2. The top-pumped optical device as set forth in claim 1, further comprising an upper cladding layer formed on the gain medium structure,
wherein the upper cladding layer is made of a material which transmits the light irradiated from the pumping light source.

3. The top-pumped optical device as set forth in claim 1,
wherein the gain medium structure does not exhibit great absorption property in a signal wavelength band of the optical device, but exhibits great absorption property in other wavelength bands.

4. The top-pumped optical device as set forth in claim 3,
wherein the gain medium is made of one selected from the group consisting of a macromolecular substance doped with excited elements, a silica-based substance doped with excited elements, a chalcogenide glass substance doped with excited elements, and a GaN or GaN-based substance doped with excited elements.

5. The top-pumped optical device as set forth in claim 4,
wherein the gain medium is doped with nano-crystals as well as the excited elements.

6. The top-pumped optical device as set forth in claim 5,
wherein the excited elements are rare-earth elements.

7. The top-pumped optical device as set forth in claim 1,
wherein the pumping light source is a LED.

8. The top-pumped optical device as set forth in claim 1,
wherein the gain medium structure includes adiabatic portions between the portion having the larger area and other portions.

9. The top-pumped optical device as set forth in claim 1,
wherein the pumping light source contacts a top surface of the upper cladding layer.
